(19) United States
(12) Patent Application Publication
(10) Pub. No.: US 2009/0217038 A1
(43) Pub. Date: Aug. 27, 2009

(54) Methods and Apparatus for Locating a Device Registration Server in a Wireless Network

(76) Inventors: Vesa Petteri Lehtovirta, Espoo (FI); Patrik Mikael Salmela, Kirkkonummi (FI); Kristian Slavov, Espoo (FI)

Correspondence Address: COATS & BENNETT, PLLC, 1400 Crescent Green, Suite 300, Cary, NC, 27518, US

(21) Appl. No.: 12/139,773

(22) Filed: Jun. 16, 2008

Related U.S. Application Data
(60) Provisional application No. 61/030,693, filed on Feb. 22, 2008.

(51) Int. Cl. G06F 21/00

(52) U.S. Cl. 713/168

(57) ABSTRACT

Methods and apparatus for locating and accessing a data server in a wireless network are disclosed. The disclosed techniques may be used to allow a wireless device provided with temporary credentials to access a wireless network and obtain a network address for a data server for downloading subscription credentials. An exemplary wireless device comprises a processing unit configured to send an access authentication request to a wireless network, and to receive an authentication challenge value from the wireless network in response. The processing unit is further configured to generate a cryptographic response from the authentication challenge value and to send the cryptographic response to the wireless network, and to also derive a data server address from the authentication challenge value. Thus, the authentication challenge value serves two purposes—as a challenge key for use in a network access authentication procedure, and as a carrier for data server address information.

### RELATED APPLICATION

This application claims priority under 35 U.S.C. § 119 (e) to U.S. provisional application Ser. No. 61/030,693, filed Feb. 22, 2008 and titled “Method of Locating DLUSIM Registration Service,” the entire contents of which are incorporated herein by reference.

### TECHNICAL FIELD

The present invention relates generally to wireless communication systems, and in particular relates to methods, apparatus, and systems for accessing a data server in a wireless network using information transferred during a network access authentication procedure.

### BACKGROUND

Machine-to-machine (M2M) communications technologies allow the deployment of wireless devices that do not require human interaction to operate. Wireless M2M devices have been deployed or proposed for a wide range of telemetry and telematics applications. Some of these applications include utility distribution system monitoring, remote vending, security systems, and fleet management.

One of the challenges for wireless M2M deployment is facilitating efficient “provisioning” of services. In particular, each wireless M2M device must be activated for operation in a particular network. With conventional 3G cellular telephones, provisioning is typically accomplished using a Universal Subscriber Identity Module (USIM), an application installed on a Universal Integrated Circuit Card (UICC) provided by the wireless network operator. The USIM/UICC may be inserted into a cellular handset to tie the handset to a particular subscription, thus allowing the handset user to access subscribed services through his home operator's network and, in many cases, through cooperating partner networks. Although reasonably convenient for individual consumers, this approach to provisioning may be impractical for an M2M application where a single entity may deploy hundreds of wireless devices across a large geographical area. For instance, in some cases a wireless device may be factory installed in a larger piece of equipment (e.g., an automobile), making later insertion of a SIM card or UICC impractical or impossible. In other instances, M2M devices may be deployed over a wide geographical area, such that no single wireless operator can provide the needed coverage. In such cases, matching the proper operator-specific USIMs to the correct devices can be problematic. Finally, re-configuring the M2M device, e.g., to transfer the device to a subscription with a different operator, can be expensive, especially when the M2M device is in a remote location.

Because of these challenges, the wireless industry has recently been investigating the possibility of downloadable subscription credentials, e.g., a downloadable USIM (or DLUSIM). In particular, the 3rd-Generation Partnership Project (3GPP) has been studying the feasibility of using DLUSIM technology for remote management of wireless M2M devices. A 3GPP report entitled “Technical Specification Group Services and System Aspects; Feasibility Study on Remote Management of USIM Application on M2M Equipment; (Release 8), 3GPP TR 33.812, is currently under development.

In one approach under study, preliminary subscription credentials, e.g., a Preliminary International Mobile Subscriber Identity and a preliminary key K, are pre-programmed into each wireless M2M device. The PIMSI and preliminary key K may be used to gain initial access to an available wireless network for the limited purpose of downloading “permanent” subscription credentials, such as a downloadable USIM. The PIMSI is associated with a registration service, which facilitates temporary access to a 3GPP network and connection to a provisioning server associated with a wireless operator offering the desired services.

The general approach is that a wireless M2M device uses the PIMSI (and the key K) to perform an initial network attachment procedure to an available network, according to conventional wireless network protocols. The network to which the device connects may be assumed to be a visited network, so that the connection is made according to roaming procedures. Once connected to the network, the M2M device establishes a connection with a provisioning server for downloading a USIM.

Although the above procedure permits an initial connection to a 3GPP network, it does not provide a complete solution for provisioning wireless M2M devices. Thus, a mechanism for linking a deployed wireless M2M device to a subscription for mobile network services from a wireless operator is needed. In particular, mechanisms for allowing a wireless M2M device to determine network addresses for accessing a registration service and/or a provisioning service are needed.

### SUMMARY

The present invention provides methods and apparatus for locating and accessing a data server in a wireless network. The disclosed techniques may be used in some embodiments to allow a wireless device provided with temporary credentials to access a wireless network and obtain a network address for a data server for downloading subscription credentials.

An exemplary wireless device according to some embodiments of the invention comprises a processing unit configured to send an access authentication request to a wireless network, and to receive an authentication challenge value from the wireless network in response. The processing unit is further configured to generate a cryptographic response from the authentication challenge value and to send the cryptographic response to the wireless network, and to also derive a data server address from the authentication challenge value. Thus, the authentication challenge value serves two purposes—as a challenge key for use in a network access authentication procedure, and as a carrier for data server address information.

In some embodiments, the access authentication request comprises a device identifier for the wireless device or a subscriber identifier for the device's user; in some cases, the device identifier or subscriber identifier may be one of a preliminary International Mobile Subscriber Identity (PIMSI), an International Mobile Subscriber Identity (IMSI), an International Mobile Equipment Identity (IMEI), and a Media Access Control (MAC) address. In some embodiments, the processing unit of the wireless device is configured to derive the data server address from the authentication challenge value by constructing the data server address using a pre-determined portion of the authentication challenge value. For example, a pre-determined portion of the authentication challenge may be combined with a pre-determined address template to form the data server address, in some embodiments. In other embodiments, the data server address may be derived by determining an index from the authentication challenge value and retrieving a stored data server address using the index.

In various embodiments of the invention, the data server address may be used to access subscription credentials for the wireless device. Thus, some embodiments of a wireless device may be configured to connect to a first data server using the data server address and to receive credential downloading information from the first data server. In some cases, subscription credentials may be downloaded directly from the first data server. In others, the credential downloading information received from the first data server may comprise a downloading server address, in which case the wireless device may be configured to connect to a downloading server corresponding to the downloading server address and to download subscription credentials. In some embodiments, the subscription credentials may comprise a downloadable Universal Subscriber Identity Module (USIM).

An exemplary authentication server according to some embodiments of the invention is configured to embed target data server information in an authentication challenge value for use by a wireless device in accessing a data server. Thus, in some embodiments of the invention, an authentication server comprises a processing unit configured to receive a security information request for a wireless device, the security information request originating at a fixed node in a wireless network. After determining data server address information for the wireless device, the processing unit generates an authentication challenge value based on the data server address information, and responds to the security information request with the authentication challenge value. In some embodiments, the security information request comprises a device identifier or subscriber identifier corresponding to the wireless device, and the processing unit is further configured to determine the data server address information for the wireless device by retrieving server information stored in association with the device identifier or subscriber identifier.

In some embodiments, the processing unit of the authentication server is configured to generate the authentication challenge value by combining the data server address information with a substantially random number. In some cases, the processing unit may be configured to concatenate the data server address information with the substantially random number to obtain the authentication challenge value.

Corresponding methods for accessing a data server via a wireless network and for providing data server access information for a wireless terminal are also disclosed.

### BRIEF DESCRIPTION OF THE DRAWINGS

FIG. 1 illustrates a communication network according to one or more embodiments of the invention.

FIG. 2 illustrates the flow of messages between a wireless M2M device, a wireless network node, and an authentication server, according to some embodiments of the invention.

FIG. 3 is a logic flow diagram illustrating an exemplary method for accessing a data server via a wireless network.

FIG. 4 illustrates an exemplary technique for constructing a network address using information obtained from an authentication challenge value.

FIG. 5 illustrates another exemplary technique for constructing a network address using information obtained from an authentication challenge value.

FIG. 6 is a logic flow diagram illustrating an exemplary method for accessing a provisioning server and downloading subscription credentials according to some embodiments of the invention.

FIG. 7 is a logic flow diagram of an exemplary method for providing data server access information for a wireless device.

FIG. 8 illustrates the construction of an authentication challenge value according to some embodiments of the invention.

FIG. 9 illustrates an exemplary wireless device.

FIG. 10 illustrates an exemplary authentication server.

### DETAILED DESCRIPTION

In the description that follows, various aspects of the present invention are described in relation to network standards promulgated by the 3rd-Generation Partnership Project (3GPP). Those skilled in the art will appreciate that these techniques may be applied to other wireless systems, for example, other systems using network access authentication procedures. Further, although the discussion below is focused on wireless M2M devices, including devices without human interfaces at all, the techniques disclosed herein are more generally applicable, and may in fact be applied to other wireless devices, including consumer handsets. Finally, those skilled in the art will appreciate that the terms “mobile terminal,” “wireless device,” wireless terminal” and the like, as used herein, are intended to include any of a wide variety of end-user devices, including in particular any of those devices referred to as “User Equipment,” “UE,” or “mobile station” by the various specifications promulgated by the 3rd-Generation Partnership or other standards groups. Indeed, these terms include wireless devices adapted for machine-to-machine (M2M) applications, as well as wireless devices adapted for fixed wireless communications. Those skilled in the art will thus appreciate that the wireless devices discussed herein may comprise cellular radiotelephones with voice communications capability, data communications capabilities, or both; personal digital assistant (PDA) devices including wireless communications capability; conventional laptop and/or palmtop computers or other appliances that include a wireless transceiver; and wireless transceiver cards and modules adapted for use in host computing devices, which may or may not be portable. Thus, the following description and accompanying drawings should be viewed as illustrative of the present invention, and not limiting.

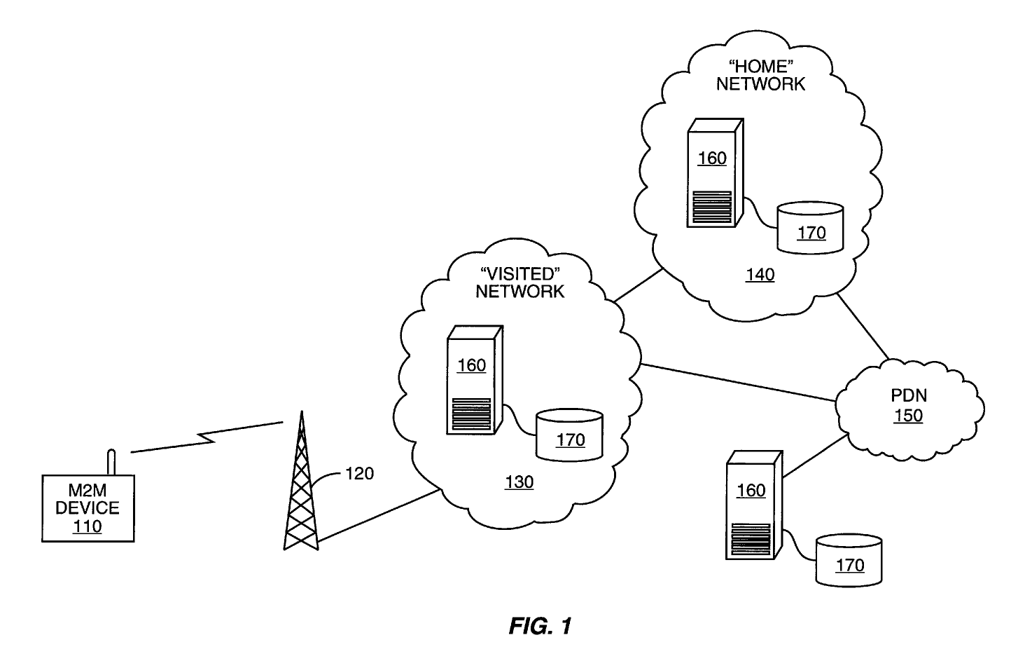

FIG. 1 illustrates a communication network according to one or more embodiments of the invention, and includes a wireless M2M device 110 communicating with a mobile communication network base station 120. In the illustrative system of FIG. 1, base station 120 provides access to a first wireless network, “visited” network 130, while the other provides access to a second wireless network, “home” network 140. Those skilled in the art will appreciate that the terms “visited” and “home” become significant only after the M2M device 110 is associated with a subscription provided by the operator of home network 140. Those skilled in the art will also appreciate that M2M device 110 may in some embodiments be a multi-mode and/or multi-band wireless device, such that it supports multiple communications protocols and/or operates at multiple frequency bands. Thus, visited network 130 and home network 140 may offer network access through similar or completely different radio access networks.

In any event, each of visited network 130 and home network 140 provide wireless data services and access to public data network (PDN) 150, which may be the Internet. Thus, in the pictured system, visited network 130 is capable of providing the M2M device 110 access to any publicly accessible resources on the Internet, as well as access to network-specific resources offered by the particular wireless network operator. In the simplified system illustrated in FIG. 1, the M2M device 110 may access any of several data servers 160 and associated databases. 170 via the visited operator network 130. Any one of the pictured data servers 160 may be an authentication server, the operation of which will be described in detail below.

As noted above, the techniques disclosed herein are generally applicable to systems utilizing downloadable USIM (DLUSIM) application problem space. Since this is a relatively new problem space, there are no fixed or specified solutions for implementing all functionality that actually enables usage of the downloadable USIM concept. A particular problem that has not been addressed adequately is how to automatically link a newly activated M2M device to an appropriate server for downloading the subscription credentials for a home operator. In general, the home operator may be selected after the device is manufactured, making it impractical to pre-program the device with a single server address. In some cases, the home operator may be selected after a device is installed in the field, again making it impractical to pre-program the device with operator-specific credential downloading instructions. Furthermore, a device owner may choose to change subscriptions, and thus change the home operator, for a device already in the field. Thus, a general solution for providing server access information is needed, for both newly activated wireless devices as well as for devices for which the corresponding subscription has been changed.

When a DLUSIM device is created, its preliminary International Mobile Subscriber Identity (PIMSI) and other related information is stored at a registration service. This registration service may be implemented at a registration server, which may be implemented, for example at one or more of the data servers 160 pictured in FIG. 1. When the user of this device eventually decides to activate the device, she will need to subscribe for mobile network usage from a wireless network operator, referred to herein as the Home Operator. Information associating a particular wireless device with the Home Operator may be stored at the registration server, along with device's PIMSI. If the Home Operator is changed, the device user may update the information at the registration service; thus, the registration service may support new activations as well as changes in subscriptions.

When a wireless device connects to a wireless network for the first time, it performs a network attachment procedure, using conventional attachment protocols. For this initial access, the device uses its PIMSI to attach to the network. The network to which the wireless device attaches may or may not be its home network. In any case, the network to which the wireless device attaches may not be associated with the device's PIMSI. Thus, the first network attachment procedure will often be executed as a roaming attachment.

In 3GPP networks, the attachment is processed according to 3GPP-defined protocols for network attachment and authentication. Accordingly, the visited network 130 will use the PIMSI information transmitted to the network by the wireless device 110 to connect to an authentication server associated with the PIMSI. To the visited network 130, this authentication server may be indistinguishable from the authentication servers deployed in other wireless networks. However, in this case the authentication server may be part of the registration service, operated expressly for the purpose of handling network attachments for devices with temporary network credentials and facilitating the download of “permanent” subscription credentials.

In response to a request for authentication data, the authentication server sends one or more authentication vectors authenticating the attaching wireless device 110 to the visited network. After a successful authentication, the visited network 130 may then proceed to complete the network attachment process for the wireless device 110 and grant access to at least some system resources. Those skilled in the art will appreciate that the authentication service may be provided by an actual wireless network operator, or a “virtual” operator providing registration-related services for newly activated devices. Thus, the authentication service may be provided using a data server deployed at any number of locations, such as at any of the data servers 160 pictured in FIG. 1.

In 3GPP networks, the visited network 130 locates the authentication service based on the PIMSI, using standard protocols. (See, for example, ITU-T Recommendation E.214, “Structure of the Land Mobile Global Title for the Signalling Control Part (SCCP)”, Telecommunication Standard Sector of ITU, November 1988, which provides a numbering plan for delivering mobility management messages in GSM networks.) Thus, the visited network 130 may use conventional authentication procedures (based on the PIMSI and a corresponding shared secret key) to authenticate the wireless device 110 and grant it access to the wireless network.

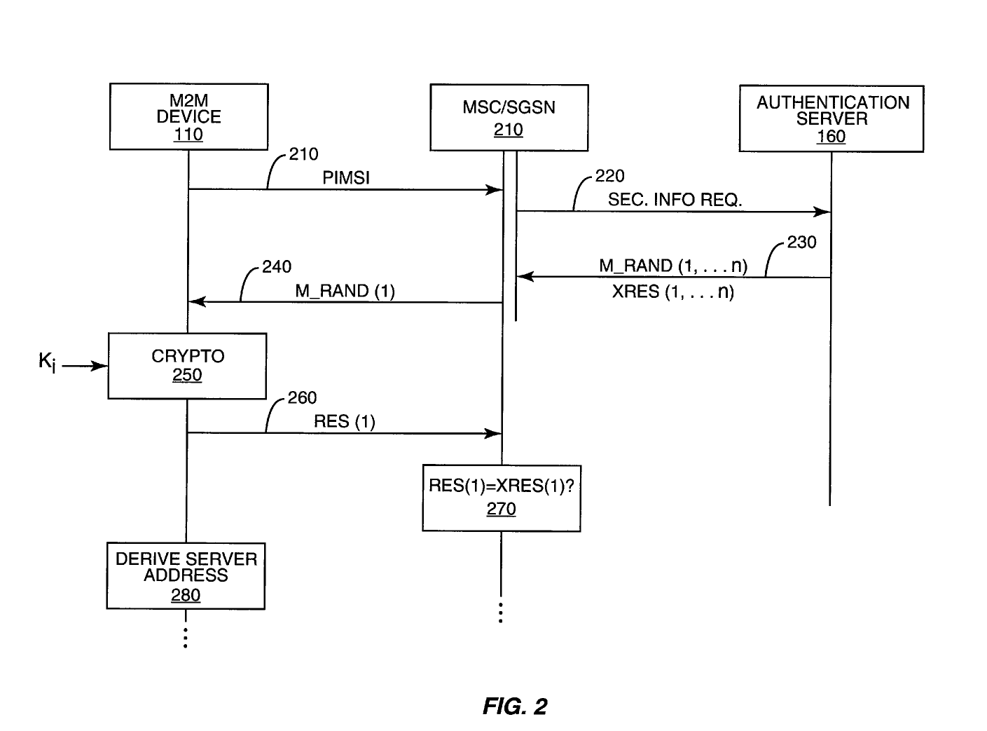

Once connected to the network with the temporary credentials, the wireless device 110 can access an appropriate data server to download subscription credentials, such as a downloadable USIM. However, the wireless device 110 first needs a network address (such as an Internet Protocol address, Uniform Resource Locator, Fully Qualified Domain Name, or the like) to locate the appropriate data server. FIG. 2 illustrates a modified authentication procedure, in accordance with some embodiments of the invention, that allows an authentication server to provide address information to the wireless device 110 for locating and downloading subscription credentials. As will be apparent to those skilled in the art, the technique illustrated in FIG. 2 may be implemented without any changes to the network infrastructure of the attached network.

The message flow of FIG. 2 begins with the wireless device 110 transmitting an access authentication request to the visited wireless network node, as shown at 210. In a 3GPP network, this access authentication request generally comprises a mobile identifier (e.g., an International Mobile Subscriber Identifier, IMSI, or Temporary Mobile Subscriber Identifier, TMSI). Here, the access authentication request 210 includes a PIMSI, which has the same format as an IMSI.

The access authentication request is processed at a fixed node in the serving wireless network, such as a Mobile Switching Center (MSC, a circuit-switching node) or Serving GPRS Support Node (SGSN, a packet-switching node), as illustrated in FIG. 2 at block 210. MSC/SGSN 210 examines the PIMSI to determine an appropriate authentication server to be contacted, and transmits a security information request to the authentication server 160, as shown at 220. In response, the authentication server 160 returns one or more authentication vectors, as shown at 230, for use by MSC/SGSN 210 in authenticating wireless device 110.

These authentication vectors 230 may, in exemplary embodiments, be configured according to standard formats, such as the formats specified in 3GPP TS 43.020 v7.2.0 and related specifications. Accordingly, the authentication vectors 230 in a 3GPP network each comprise a 128-bit authentication challenge value as well as a 32-bit “expected response” value. The expected response value, or ARES, is generated by the authentication server 160 as a cryptographic function of the authentication challenge value and a 128-bit secret key that is known only to the wireless device 110 and the authentication server 160. The wireless device's identity may thus be “proven” by determining whether the wireless device 110 can produce the same cryptographic response from the authentication challenge value.

In many conventional authentication schemes, the authentication challenge value (called RAND in 3G systems) is randomly generated. In some embodiments of the present invention, however, the authentication challenge value is modified to include information from which the wireless device 110 may derive a network address for a data server. Thus, in the message flow of FIG. 2, data server address information is embedded in the modified random authentication challenge (M_RAND). As described in more detail below, these modifications to the authentication challenge value need not change the format of the authentication messages in any way. As a result, MSC/SGSN 210 (and other nodes in the visited wireless network) need not be modified to handle the modified authentication challenges.

In any event, at least a first one of the authentication challenge values, M_RAND(1), is forwarded to the wireless device 110, as shown at 240. Wireless device 110 computes a response value, RES(1), as a cryptographic function of the authentication challenge value and a secret key, Kᵢ, as shown at block 250. Because the wireless device 110 uses the same cryptographic function as the authentication server 160 (in GSM systems, the so-called A3 algorithm) and has shared knowledge of the secret key Kᵢ, the resulting response value RES(1) is identical to the corresponding expected response XRES(1) computed by the authentication server 160. Thus, wireless device 110 forwards RES(1) to MSC/SGSN 210 for verification, as shown at 260. At block 270, RES(1) is compared to ARES(1); a match confirms that wireless device possesses the secret key Kᵢ. Because only the wireless device actually corresponding to the originally-transmitted PIMSI should have that secret key, this process confirms the identity of wireless device 110. The visited network may then permit the wireless device 110 to access the network.

As noted above, however, the authentication challenge value M_RAND(1) includes embedded data server address information. Wireless device 110 thus extracts this embedded information and derives a server address, as shown at block 280. Several approaches to embedding address information and the corresponding approaches to determining a server address from the authentication challenge value are provided below.

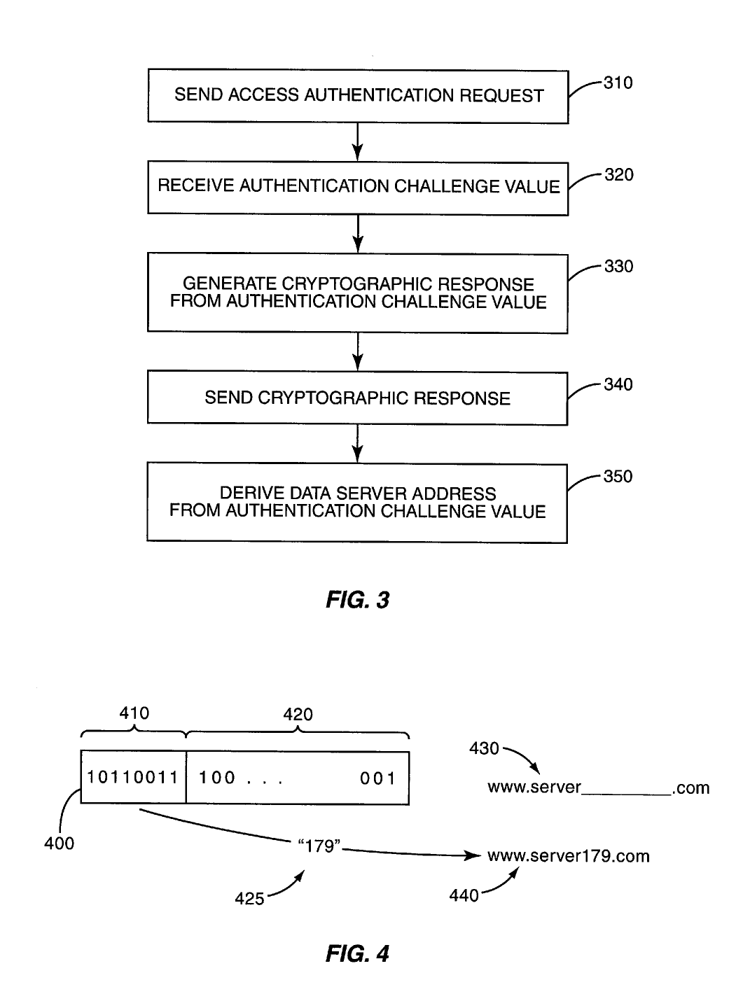

FIG. 3 illustrates a general method for accessing a data server via a wireless network, such as might be implemented at wireless device 110. Those skilled in the art will appreciate that the message flow described above for a 3G system is consistent with some embodiments of the method of FIG. 3, but that the method of FIG. 3 may also be applicable to other systems employing challenge-response authentication schemes and other wireless devices.

The method of FIG. 3 begins at block 310, with the sending of an access authentication request to the wireless network. In general, this access authentication request may be any message that triggers an authentication process. In some cases, as noted above, this access authentication request may comprise a device identifier, such as a PIMSI. (An International Mobile Subscriber Identity, or IMSI, is technically an identifier for a subscriber, rather than the device. Of course, in practice, it often functions as a device identifier. Further, in the case of an M2M device the PIMSI may be permanently or semi-permanently associated with the wireless device at the time of manufacture. With respect to the inventive techniques disclosed herein, the distinction between a subscriber identifier and a device identifier is not important; thus, the terms are generally used interchangeably herein.) In others, a device identifier may be provided to the network via some other message. In some embodiments, the access authentication request may be formatted according to a standard authentication protocol such as the 3GPP security protocols described in 3GPP TS 43.020 v7.2.0 and related specifications.

When the inventive techniques disclosed herein are employed in a 3GPP network, the identifier supplied to the network to trigger the authentication process may comprise an International Mobile Subscriber Identity (IMSI) or preliminary International Mobile Subscriber Identity. The International Mobile Subscriber Identity, or IMSI, is technically a subscriber identity, rather than a device identifier. Of course, in practice, it often functions as a device identifier. Further, in the case of an M2M device the PIMSI may be permanently or semi-permanently associated with the wireless device at the time of manufacture. With respect to the inventive techniques disclosed herein, the distinction between a subscriber identifier and a device identifier is not important; thus, the terms are generally used interchangeably herein.

Those skilled in the art will appreciate that the inventive methods and apparatus disclosed herein may use device or subscriber identifiers other than an IMSI or PIMSI. For example, an International Mobile Equipment Identity (IMEI) may be used in some embodiments. In other embodiments, a Media Access Control (MAC) address for the wireless device may be used.

At block 320, an authentication challenge value is received from the wireless network in response to the access authentication request. As described above, the authentication challenge value may comprise a 128-bit value in some embodiments, although other sizes are possible.

At block 330, the wireless device seeking access to the network generates a cryptographic response from the authentication challenge value, according to the authentication procedures appropriate for the accessed wireless network. Thus, in a 3GPP scenario, the wireless device uses a 128-bit device-specific secret key Kᵢ and the 128-bit authentication challenge value to generate a 32-bit response, using the A3 cryptographic algorithm. In other embodiments, other cryptographic functions may be used. Generally, the cryptographic function should be a one-way function, such that it is extremely difficult to derive or guess the input values from the output value. Such functions are well known and widely used for authentication purposes.

At block 340, the cryptographic response is sent to the wireless network, which may compare it to an expected response to authenticate the wireless device. Generally, upon successful authentication the device is granted access to at least some network resources.

At block 350, the authentication challenge value is used for a second purpose: to derive a data server address. In exemplary embodiments, this data server address may comprise a network address for a registration server, from which the wireless device 110 may retrieve information related to downloading subscription credentials, such as an address for a credential downloading data server. In other embodiments, the network address may directly indicate a credential downloading server.

The exact procedure for deriving the data server address depends on the method employed to embed server address information in the authentication challenge value. That method in turn depends on the actual deployment model of device registration services, such as those currently being defined by 3GPP. One possibility is that the accessing wireless device is directed to one of only a relatively few global (or per-continent or per-country) registration services. In such a scenario, an 8-bit value communicated via the authentication challenge value would be sufficient to uniquely indicate each such service. On the other hand, if each network operator in the world maintained its own registration service then more than eight bits of the authentication challenge value may be needed for identifying the registration service.

One exemplary approach is illustrated in FIG. 4. In some embodiments, a pre-determined portion of the authentication challenge value may be used to determine the data server address. In the pictured approach, the pre-determined portion 410 of the authentication challenge 400 comprises the first eight bits. The remaining bits 420 may be randomly generated to maintain the security of the authentication process at a high level. In any event, the initial bits 410 are decoded to form an alphanumeric value 425, which is applied to a pre-determined address template 430 to yield a Uniform Resource Locator (URL) 440. In the particular example illustrated, the first eight bits (“10110011”) represent the value “179” in decimal. This decimal value is converted to text and applied to a template “www.server______.com” to yield a URL “www.server179.com”. The pictured approach is of course only an example; various methods for decoding the pre-determined portion 410 may be used, and a variety of template forms or address types may be used. For instance, a URL is used in the example of FIG. 4; a different embodiment might use the same decoded decimal value “179” as part of an IP address or other form of network address.

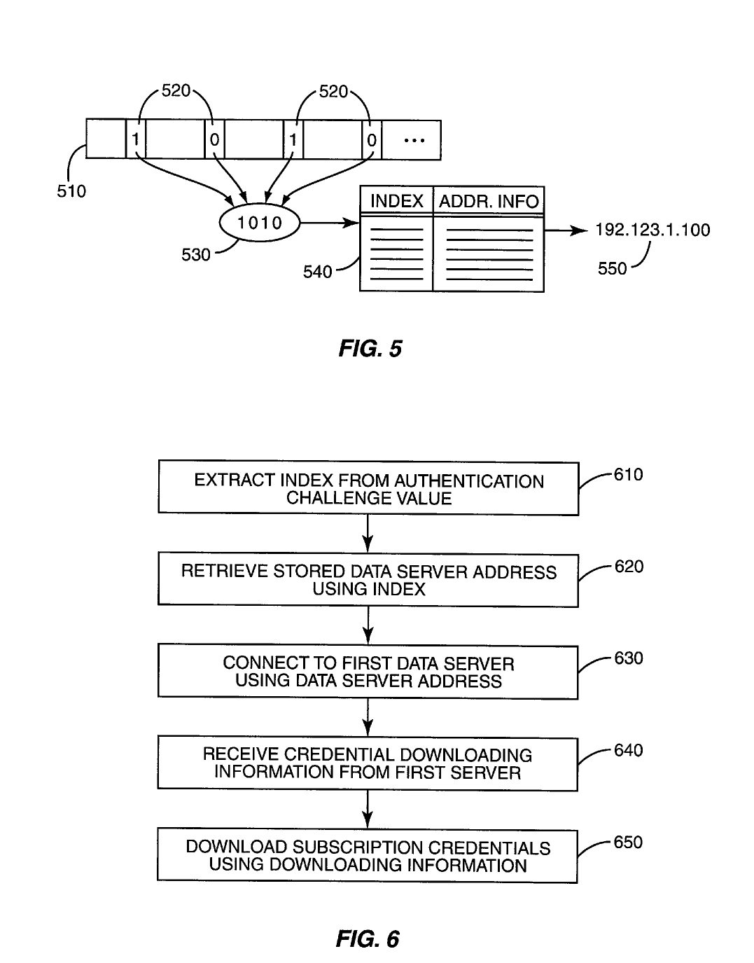

Another approach is pictured in FIG. 5, where several individual data bits 520 are extracted from the authentication challenge value 510, to form an index 530. The index 530 is used to access a look-up table 540 stored in the wireless device. The look-up table 540 holds several stored data server addresses; the index 530 is used to retrieve a particular stored network address 550. The stored network address 550 in FIG. 5 comprises an IP address, but any type of network address may be used.

The general approach pictured in FIG. 5 is also illustrated in the logic flow diagram of FIG. 6, which depicts an exemplary method for determining a server address from an authentication challenge value and using that server address to obtain subscription credentials.

Thus, at block 610, an authentication challenge value received from a wireless network is used to extract an index value. The index value may comprise a pre-determined contiguous portion of the authentication challenge value, or may be formed by concatenating several bits or fields extracted from several pre-determined locations in the authentication challenge value. At block 620, the index value is used to retrieve a stored data server address, e.g., using a look-up table.

At block 630, the data server address is used to connect to a first data server, via the wireless network. In some embodiments, this first data server may comprise a registration server, in which device identifiers, such as PIMSIs, are stored in association with subscription information. This subscription information may, for instance, identify the “home” operator or home network for a newly activated device.

The subscription information may in particular include credential downloading information for the device. Thus, at block 640, the wireless device receives credential downloading information from the first data server. The wireless device uses that credential downloading information to download subscription credentials at block 650. These subscription credentials may be used for subsequent accesses to the wireless network, to gain full access to subscribed services and resources.

In some embodiments, the first data server may provide a credential downloading service itself. In other embodiments, however, the subscription information accessible to the wireless device may include a second network address, e.g., a downloading server address, for use in accessing and downloading subscription credentials, such as a downloadable USIM, from a second data server. In any event, those skilled in the art will appreciate that this first data server may in some cases be provided using the same data server or servers used to provide the authentication services discussed above and/or to provide more general subscription registration services for wireless devices.

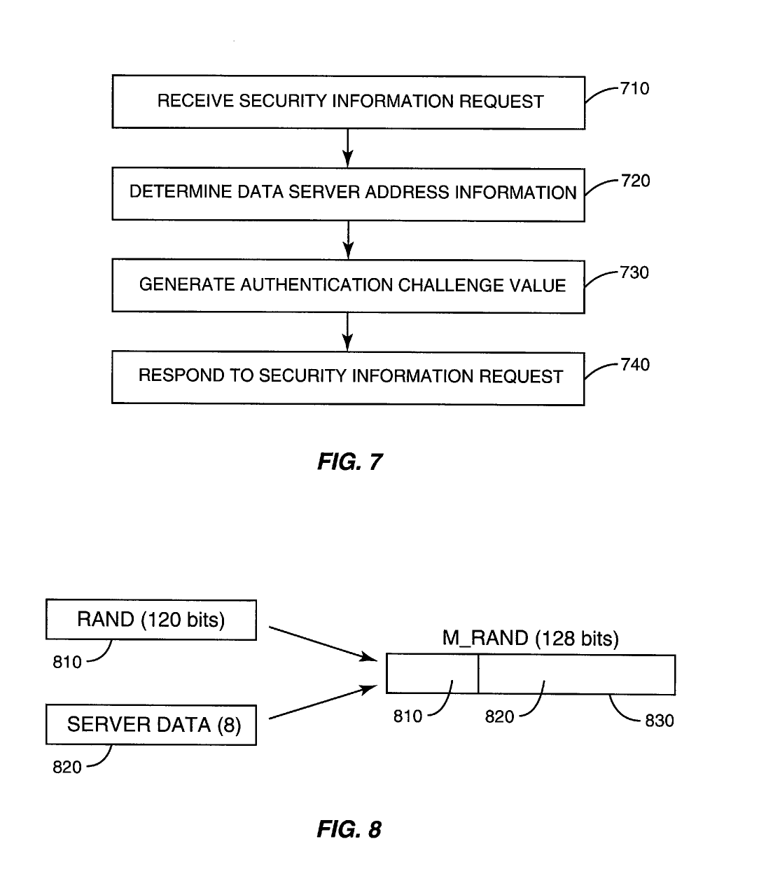

FIG. 7 illustrates an exemplary method for providing data server access information for a wireless device, such as might be implemented at an authentication server. The method begins at block 710, with the receipt of a request for security information. As noted above, in a 3GPP system this security information request may be sent from an MSC or SGSN; in other embodiments the security information request may originate from some other fixed node in a wireless network that seeks to authenticate a wireless device.

At block 720, the authentication server determines data server address information that is to be communicated to the wireless device being authenticated. This may be done, for instance, by retrieving subscription-related information for the wireless device using a device identifier for the wireless device. Thus, in some embodiments the security information request may include or be accompanied by a device identifier for the wireless device, such as a PIMSI. In some embodiments, data server address information may be stored in association with the device identifier, and thus directly retrieved. In others, the device identifier may be used to identify a home network or home operator, and this information used to retrieve appropriate data server address information.

At block 730, an authentication challenge value is generated, based at least in part on the data server address information. Thus, information indicating a particular data server is embedded into the authentication challenge value. At block 740, the authentication challenge value is sent back to the requesting node, in response to the security information request, for forwarding to the wireless device.

As noted above, data server address information may be embedded into the authentication challenge value in several different ways. One approach is shown in FIG. 8, where a 120-bit random value 810 is concatenated with an 8-bit server data value 820, to form a 128-bit authentication challenge value 830. Of course, different lengths for the server data value 820 or random value 810 may be used. Similarly, the server data value 820 may appear at the end of the authentication challenge value 830, or somewhere in the middle, or may be broken into individual bits or groups of bits and distributed at various locations in the authentication challenge value. The random value 810 may be generated according to known techniques for generating random or substantially random values for cryptographic and other applications.

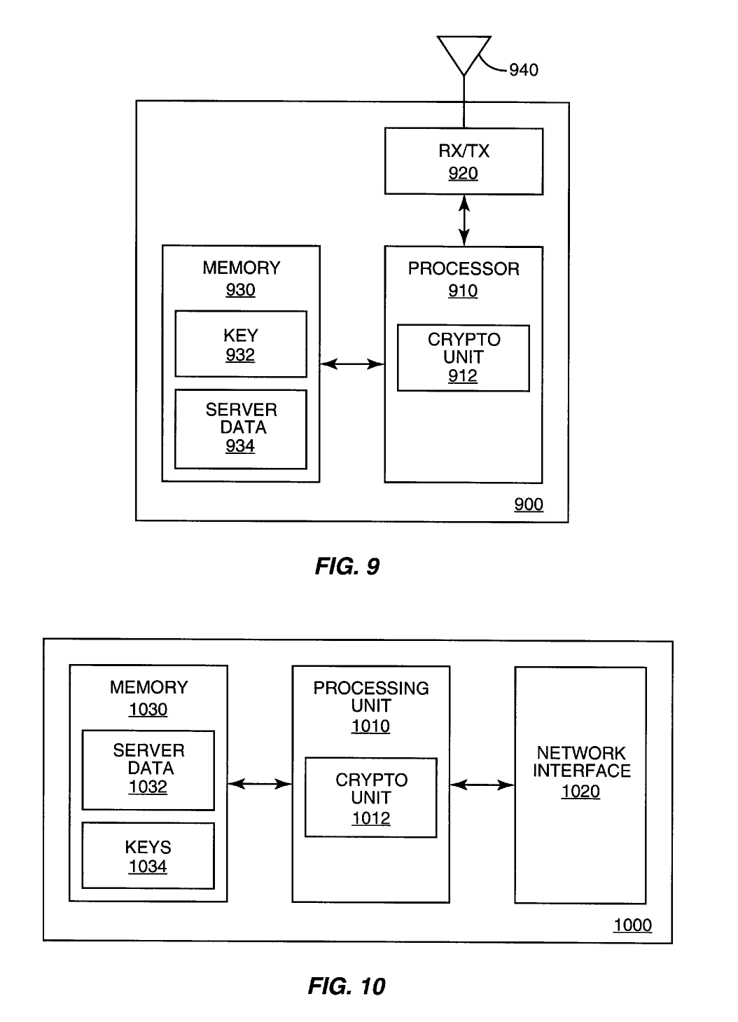

FIG. 9 illustrates a wireless device 900 according to one or more embodiments of the present invention. Wireless device 900 includes a processing unit 910, a wireless transceiver 920, and memory 930. Wireless transceiver 920 may be configured for communication with a wireless network according to one or more wireless communication standards, such as any of those promulgated by 3GPP. In some embodiments, processing unit 910 is configured to carry out one or more of the methods described above for accessing a network, determining a data server address from an authentication challenge value, and/or accessing a data server for downloading subscription credentials. In particular, processing unit 910 in some embodiments may be configured to send an access authentication request to the wireless network using radio transceiver 920 and antenna 940, and to receive an authentication challenge value from the wireless network in response. Processing unit 910 may be further configured to generate a cryptographic response from the authentication challenge value, using cryptographic unit 912, and to send the cryptographic response to the wireless network, using radio transceiver 920. Finally, processing unit 910 is configured to derive a data server address from the authentication challenge value.

Those skilled in the art will appreciate that processing unit 910 may comprise one or more general-purpose or special-purpose microprocessors, microcontrollers, or digital signal processing units. In some embodiments, processing unit 910 may comprise a general purpose processing unit programmed to implement a wireless communications protocol according to one or more published standards, including one or more network access authentication protocols as described above. In various embodiments, the same processor or controller, or a different processor or controller, may be programmed to derive a data server address from a received authentication value and to connect to a corresponding data server. In some embodiments, cryptographic unit 912 may comprise a separate hardware unit or software programmable unit specially adapted for cryptographic processing units. Memory 930 may contain program data for processing unit 910 in addition to server data 934 for use in determining a data server address from an authentication challenge value and a secret key 932 for use in generating a response to the authentication challenge value. Memory 930 may comprise one or several memory devices of one or more types including Flash, RAM, ROM, hard-disk drives, optical storage devices and the like. Memory 930 may include tamper-resistant memory for storing key 932 and other security-related data; in some embodiments a secure portion of memory 930 may be implemented on the same chip as cryptographic processor unit 912 to provide a single tamper-resistant cryptographic element.

FIG. 10 illustrates an exemplary authentication server 1000 according to one or more embodiments of the invention. Authentication server 1000, which may be implemented, for example, at any of the data servers 160 pictured in FIG. 1, comprises a processing unit 1010, network interface 1020 and memory 1030. Network interface 1020 comprises hardware, software drivers, and protocol stacks for providing connectivity to a private data network and/or a public data network. For instance, network interface 1020 may comprise hardware configured for connection to a wired data network via a standard Ethernet interface and a standard TCIP/IP protocol stack. In some embodiments, network interface 1020 may provide two or more separate interfaces to separate networks. Thus, network interface 1020 may provide a signaling interface for communicating with control elements of one or more wireless networks, as well as a public data network interface for communicating with a public data network such as the Internet.

Processing unit 1010 comprises one or more general-purpose or special-purpose microprocessors, microcontrollers, or digital signal processors programmed to carry out one or more of the methods described above for authenticating a wireless device, including the generation of an authentication challenge value based on a target data server address corresponding to the wireless device. Processing unit 1010 may further comprise a cryptographic processing unit 1012 configured to carry out one or more cryptographic functions such as the A3 authentication algorithm used for authenticating GSM devices.

In some embodiments, processing unit 1010 is configured to receive a security information request for a wireless device, via the network interface 1020. The security information request may originate at a fixed node in a local or remote wireless network, such as an MSC or SGSN in a 3G network. The processing unit 1010 determines target data server address information corresponding to the wireless device, in some embodiments by retrieving the target data server address information from a look-up table or database using a device identifier supplied in or with the security information request. In some embodiments, this device identifier may comprise a PIMSI. In other embodiments, a target data server may be selected from several available data servers based on a geographical location of the wireless device. In some embodiments, location information for the wireless device may be provided by a location server, using one or more of a variety of network-based, handset-based, or hybrid positioning technologies. In other embodiments, however, the general location of the wireless device may be determined by other means, such as by determining a location associated with a network identifier corresponding to the network that provided the security information request.

In any event, the processing unit 1010 may be configured to generate an authentication challenge value, based on the target data server address information, and to respond to the security information request with the authentication challenge value. As described above, the authentication challenge value may be forwarded to the wireless device by the wireless network and used by the wireless device to determine the address of the target data server.

Those skilled in the art will appreciate that processing unit 1010 may comprise one or more general-purpose or special-purpose microprocessors, microcontrollers, or digital signal processing units. In some embodiments, cryptographic unit 1012 may comprise a separate hardware unit or software-programmable unit specially adapted for cryptographic processing units. Memory 1030 may contain program data for processing unit 1030 in addition to target data server address information 1034 and a secret key 1034 for each of several wireless devices, for use in generating an authentication challenge value. Memory 1030 may comprise one or several memory devices of one or more types including Flash, RAM, ROM, hard-disk drives, optical storage devices, and the like. Memory 1030 may in some embodiments include tamper-resistant memory for storing keys 1032 and other security-related data; in some embodiments a secure portion of memory 1030 may be implemented on the same chip as cryptographic processor unit 1012 to provide a single tamper-resistant cryptographic element.

The present invention may, of course, be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method for accessing a data server via a wireless network, the method comprising:
sending an access authentication request to the wireless network;
receiving an authentication challenge value from the wireless network in response to the access authentication request;
generating a cryptographic response from the authentication challenge value and sending the cryptographic response to the wireless network; and
deriving a data server address from the authentication challenge value.

2. The method of claim 1, wherein sending an access authentication request to the wireless network comprises sending a device identifier or subscriber identifier to the wireless network.

3. The method of claim 2, wherein the device identifier or subscriber identifier comprises one of a preliminary International Mobile Subscriber Identity, an International Mobile Subscriber Identity, an International Mobile Equipment Identity, and a Media Access Control address.

4. The method of claim 1, wherein deriving a data server address from the authentication challenge value comprises constructing the data server address using a pre-determined portion of the authentication challenge value.

5. The method of claim 4, wherein constructing the data server address comprises combining the pre-determined portion of the authentication challenge value with a pre-determined address template.

6. The method of claim 1, wherein deriving a data server address from the authentication challenge value comprises determining an index from the authentication challenge value and retrieving a stored data server address using the index.

7. The method of claim 1, further comprising accessing subscription credentials using the data server address.

8. The method of claim 7, wherein accessing subscription credentials using the data server address comprises connecting to a first data server using the data server address and receiving credential downloading information from the first data server.

9. The method of claim 8, wherein the credential downloading information comprises a downloading server address, further comprising downloading the subscription credentials from a downloading server corresponding to the downloading server address.

10. A method for providing data server access information for a wireless device, the method comprising:
receiving a security information request for a wireless device;
determining data server address information corresponding to the wireless device;
generating an authentication challenge value based on the data server address information; and
responding to the security information request with the authentication challenge value.

11. The method of claim 10, wherein the security information request comprises a device identifier or subscriber identifier corresponding to the wireless device, and wherein determining data server address information corresponding to the wireless device comprises retrieving server information stored in association with the device identifier or subscriber identifier.

12. The method of claim 10, wherein generating the authentication challenge value comprises combining the data server address information with a substantially random number to obtain the authentication challenge value.

13. The method of claim 12, wherein combining the data server address information with the substantially random number comprises concatenating the substantially random number to the data server address information to obtain the authentication challenge value.

14. The method of claim 10, wherein the security information request is received from a fixed node in a serving wireless network, and wherein responding to the security information request comprises sending the authentication challenge value to the fixed node for forwarding to the wireless device.

15. The method of claim 14, wherein the fixed node in the serving wireless network comprises a circuit switching node or packet switching node.

16. A wireless device comprising a radio transceiver for communicating with a wireless network and a processing unit configured to:
send an access authentication request to the wireless network using the radio transceiver;
receive an authentication challenge value from the wireless network in response to the access authentication request;
generate a cryptographic response from the authentication challenge value;
send the cryptographic response to the wireless network using the radio transceiver; and
derive a data server address from the authentication challenge value.

17. The wireless device of claim 16, wherein the access authentication request comprises a device identifier or subscriber identifier stored in the wireless device.

18. The wireless device of claim 16, wherein the processing unit is configured to derive the data server address from the authentication challenge value by constructing the data server address using a pre-determined portion of the authentication challenge value.

19. The wireless device of claim 18, wherein the processing unit is configured to construct the data server address by combining the pre-determined portion of the authentication challenge value with a pre-determined address template.

20. The wireless device of claim 16, wherein the processing unit is configured to derive the data server address from the authentication challenge value by determining an index from the authentication challenge value and retrieving a stored data server address using the index.

21. The wireless device of claim 16, wherein the processing unit is further configured to access subscription credentials using the radio transceiver and the data server address.

22. The wireless device of claim 21, wherein the processing unit is configured to access subscription credentials by connecting to a first data server using the data server address and receiving credential downloading information from the first data server.

23. The wireless device of claim 22, wherein the credential downloading information comprises a downloading server address, and wherein the processing unit is further configured to download the subscription credentials, using the radio transceiver, from a downloading server corresponding to the downloading server address.

24. An authentication server in a wireless network, the authentication server comprising an authentication processing unit configured to:
receive a security information request for a wireless device;
determine data server address information corresponding to the wireless device;
generating an authentication challenge value based on the data server address information; and
respond to the security information request with the authentication challenge value.

25. The authentication server of claim 24, wherein the security information request comprises a device identifier or subscriber identifier corresponding to the wireless device, and wherein the authentication processing unit is configured to determine the data server address information by retrieving server information stored in association with the device identifier or subscriber identifier.

26. The authentication server of claim 24, wherein the authentication processing unit is configured to generate the authentication challenge value by combining the data server address information with a substantially random number to obtain the authentication challenge value.

27. The authentication server of claim 26, wherein the authentication processing unit is configured to combine the data server address information with the substantially random number by concatenating the substantially random number to the data server address information to obtain the authentication challenge value.

28. The authentication server of claim 24, wherein the security information request is received from a fixed node in a serving wireless network and wherein the authentication processing unit is configured to respond to the security information request by sending the authentication challenge value to the fixed node for forwarding to the wireless device.
